(19) United States
(12) Patent Application Publication
(10) Pub. No.: US 2011/0080472 A1
(43) Pub. Date: Apr. 7, 2011

(54) AUTOSTEREOSCOPIC STATUS DISPLAY

(76) Inventor: Eric Gagneraud, Spring, TX (US)

(21) Appl. No.: 12/572,332

(22) Filed: Oct. 2, 2009

(51) Int. Cl. H04N 13/04; G02B 27/22

(52) U.S. Cl. 348/51; 359/463; 348/E13.001

(57) ABSTRACT

A system and method for autostereoscopically displaying status of a computer-based device are disclosed herein. A computer includes a display configured to provide autostereoscopic viewing of computer status. The computer generates and provides to the display data configured for three-dimensional display.

### BACKGROUND

Computers and other computer-based devices generally include a means of communicating device status to a user. Device status includes device operational information, such as network connection status. Some devices may display such status in a portion of the device's display screen. Other devices may use light emitting diodes or other indicators to communicate device status.

### BRIEF DESCRIPTION OF THE DRAWINGS

For a detailed description of exemplary embodiments of the invention, reference will now be made to the accompanying drawings in which:

FIG. 1 shows a computer including a dedicated autostereoscopic status display in accordance with various embodiments;

FIG. 2 shows an autostereoscopic status display in accordance with various embodiments;

FIG. 3 shows a block diagram of a system including an autostereoscopic status display in accordance with various embodiments; and

FIG. 4 shows a flow diagram for a method for generating an autostereoscopic status display in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A computer-based device may provide information regarding the state of the device by a variety of means. For example, an audio alarm may be used indicate device failure or errors. Status that is frequently referenced may be presented on a device's display screen or assigned a dedicated visual indicator. For example, a dedicated graphic with controllable backlighting may be provided to indicate a state of a device subsystem. Similarly, a graphic may be rendered on the device's display screen to provide device status information.

Embodiments of the present disclosure include a dedicated status display configured to provide autostereoscopic viewing of device status information. Autostereoscopic viewing is viewing a three-dimensional image without use of apparatus (i.e., special glasses) other than the display device. An autostereoscopic display device is a display device configured to provide three-dimensional images without the use of additional apparatus. The graphics provided via the status display of the present disclosure are changeable, thereby enhancing the flexibility of the display. Some embodiments of the display continue to present an image when the device is unpowered, allowing a user to view a last status of the device. Some embodiments of the display advantageously reduce device power consumption by requiring power only when changing a displayed image.

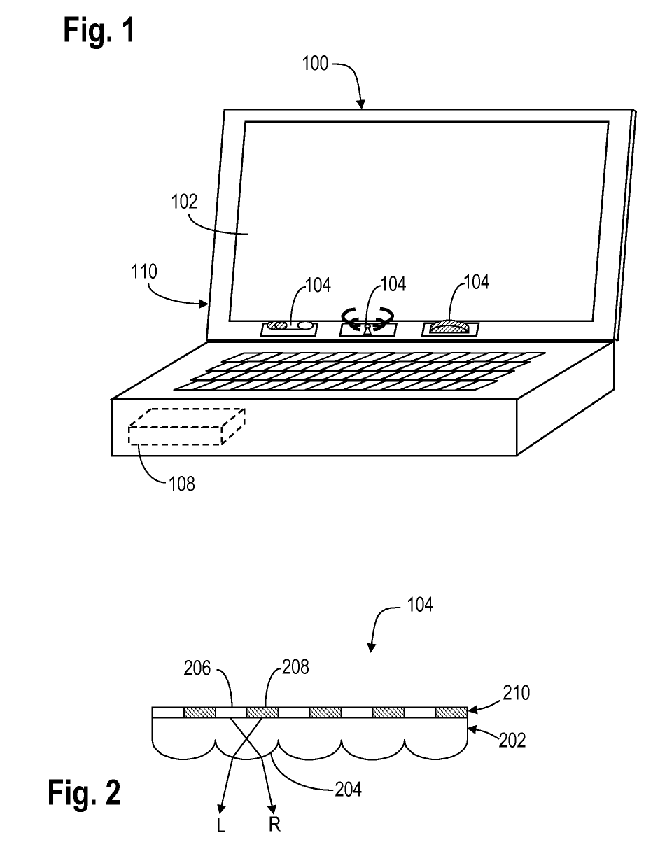

FIG. 1 shows a computer including a dedicated autostereoscopic status display in accordance with various embodiments. The computer 100 includes an enclosure 110 for housing the components of the computer 100, a display screen 102 configured for rendering two-dimensional images, and an autostereoscopic status display 104. The display screen 102 may use any appropriate display technology. For example, liquid crystal display, organic light emitting diode, projection, plasma, etc. may be used. Three dedicated autostereoscopic status displays 104 are illustrated in the example of FIG. 1. In other embodiments, a different number of status displays 104 are included. Some embodiments may subdivide a status display 104 to present multiple status indicators.

As a matter of convenience, the autostereoscopic status display 104 is illustrated as located just below the screen 102. Embodiments may locate the status display 104 in any convenient location, for example, above, below, or to the side of the keyboard. The autostereoscopic status display 104 is configured to provide device status to a user in the form of three-dimensional images. Thus, a user viewing the status display 104 may perceive, for example, an image of a battery projecting outward from the display. The battery image may provide information indicative of the charge level of the device's battery. A variety of device status information can be presented on the graphically mutable display 104, allowing a single display 104 to show varying status and/or different types of status. Other illustrated examples of status that may be displayed on the autostereoscopic status display 104 include signal strength of a wireless network and audio volume level.

FIG. 2 shows an autostereoscopic status display 104 in accordance with various embodiments. The display 104 includes a lenticular lens screen 202 disposed over a graphically mutable two-dimensional display device 210. The lenticular screen 202 is a sheet having a series of narrow vertical cylindrical lenses 204 (lenticules). Strips of two images of a status symbol viewed from different angles may be positioned under each lenticule 204. For example, display elements 208 may display a strip of an image to be viewed from a user's left eye, and display elements 206 may display a strip of an image to be viewed from a user's right eye. Embodiments of the status display 104 accurately align the lenticule 204 with the display elements 206, 208. For example, the lenticule 204 is positioned in alignment with the display element (e.g., pixel) columns 206, 208. The lenticular screen 202 operates to provide a view of display elements 206 to the user's right eye and the view of display elements 208 to the user's left eye. The difference or displacement of an object from the left to the right image determines the depth of the object seen by the user. Thus, the status display 104 presents images that convey the illusion of three-dimensionality.

In some embodiments, the two-dimensional display 210 disposed beneath the lenticular screen 202 may be a sheet of electronic paper (“e-paper”). E-paper is a reflective display technology (i.e., e-paper does not require backlighting) that once set to display an image, retains the image display without consuming additional power. Embodiments of e-paper may produce color or gray scale displays.

One embodiment of e-paper comprises a sheet including a multitude of capsules. Each capsule contains charged particles of one color (e.g., black) and oppositely charged particle of a different color (e.g., white). Via electrodes disposed on opposite sides of each capsule, an electric field is applied to the capsules. The electric field causes the particles to move from one side of the capsule to the other in accordance with the field and particle charge polarities. Thus, a selected color may be presented to the viewer. Once the charged particles have been moved to a new position, no power is consumed to keep the particles in the new position.

By overlaying a lenticular screen 202 on a mutable two-dimensional graphical display technology, such as e-paper, the status display 104 can present a three-dimensional display of device status to a user. Because a user of computer 100 or other computer based device is positioned in close proximity to the status display 104, the display 104 can include a high-density lenticular screen (e.g., 75-100 lines per inch) thereby allowing a higher quality rendering of a status symbol.

To produce a three dimensional status image on the display 104, the device 100 generates in its internal storage 108, a plurality of views of elements of the status image as observed from different angles. Each view is subdivided into a plurality of vertical strips, the width of each strip being a fraction (e.g., %) of the width of a lenticule 204. The strips of the views are interlaced to form a composite image that is written to the two-dimensional display 210 of status display 104.

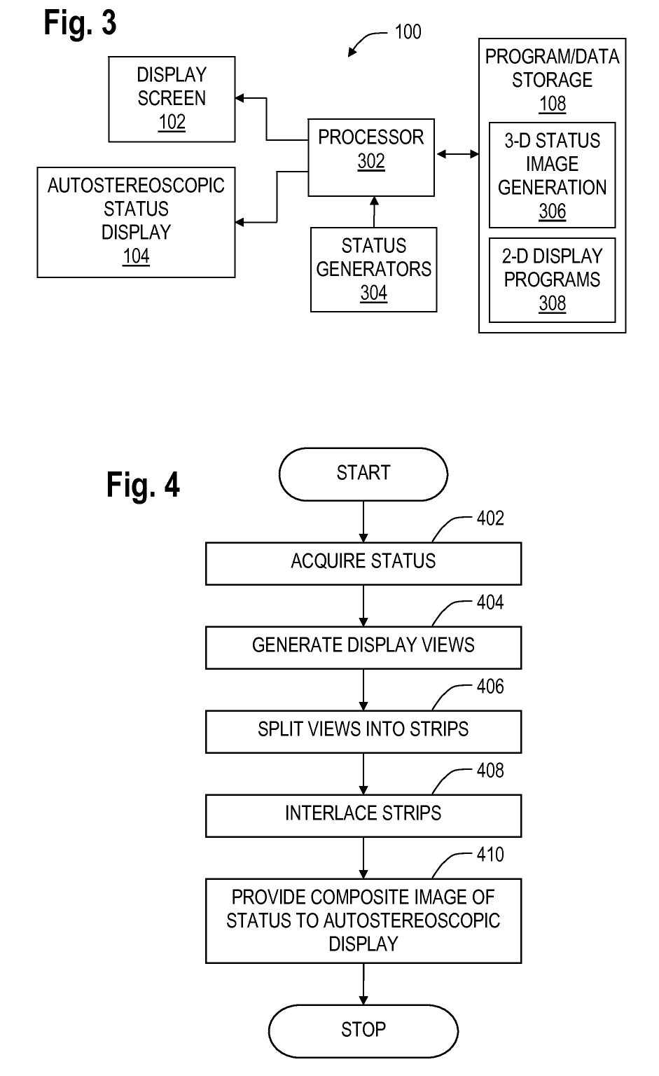

FIG. 3 shows a block diagram of a computer-based device including an autostereoscopic status display in accordance with various embodiments. The device 100 includes a processor 302, program/data storage 108, status generators 304, a display screen 102 for providing two-dimensional images, and an autostereoscopic status display 104. The processor 302 may be, for example, a general-purpose microprocessor, a digital signal processor, a microcontroller, etc. The processor 302 executes program instructions provided from a computer readable medium, such as storage 108. Embodiments of the processor 302 can include execution units (e.g., integer, fixed point, floating point, etc.), instruction decoders, storage units (e.g., memory, registers, etc.), input/output sub-systems (e.g., bus interfaces), peripherals (e.g., timers, interrupt controllers, direct memory access controllers, etc.), interconnecting buses, etc.

The storage 108 provides data and program storage for the processor 302 and other device 100 sub-systems. The storage 108 may include any of a variety of memory technologies accessible by the processor 302, for example, semiconductor memory, magnetic storage, optical storage, etc. The storage 108 may be volatile, non-volatile, or combinations thereof. In some embodiments, the storage 108 may be a CD-ROM or other optical disc.

The storage 108 includes software programming 306 that when executed causes the processor 302 to generate status images that when displayed via the autostereoscopic status display 104 appear three-dimensional. The storage 108 also includes software programming 308 that is not configured to provide three-dimensional images to the status display 104, but rather provides two-dimensional displays for presentation via the display screen 102.

The status generators 304 are coupled to the processor 302, and represent subsystems of the device 100 configured to generate status that may be displayed via the status display 104. The status generators may hardware or software components. For example, a power system of the device 100 may provide information indicating the level of charge of a battery powering the device 100, a wireless networking system of the device 100 may provide information indicating a power level of detected network RF signals, etc. The status values provided by the status generators 304 are processed by execution of the 3-D image generation software 306 executed by the processor 302 to produce three-dimensional status displays.

FIG. 4 shows a flow diagram for a method for generating an autostereoscopic status display in accordance with various embodiments. Though depicted sequentially as a matter of convenience, at least some of the actions shown can be performed in a different order and/or performed in parallel. Additionally, some embodiments may perform only some of the actions shown. At least some of the operations shown in FIG. 3 can be implemented via software programming stored in a computer-readable medium (e.g., storage 108) and executed by a processor 302.

In block 402, the processor 302 of the computer-based device 100 acquires device 100 related status from the status generators 304. The status may be, for example, an audio volume level, a level of RF frequency signals detected on a wireless network, a battery charge level, etc.

In block 404, the processor 302 generates a plurality of views of a status image. For example, if the image is that of a battery showing a charge level, a first view may be generated showing the battery from an angle to the right and second view may be generated showing the battery from an angle to the left.

In block 406, the processor 302 subdivides each of the views into vertical strips. The width of the strips is determined by the width of a lenticule of the lenticular screen. For example, if a lenticular screen has 75 lines (i.e., lenticules) per inch and the two-dimensional display beneath the lenticular screen has 150 dots per inch, then a view may be subdivided into 1 dot width strips.

In block 408, the processor 302 interlaces the vertical strips derived from the views to produce a composite image. The strips are ordered such that a user's right eye is provided the view generated from an angle to the right and the user's left eye is provided the view generated from an angle to the left.

In block 410, the processor 302 writes the composite image of the status to the autostereoscopic status display 104 for viewing by the user.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
an enclosure configured to house components of the computer system;
a primary display configured to provide two-dimensional viewing of information, and housed in the enclosure;
a secondary display configured to provide autostereoscopic viewing of computer system status information, and housed in the enclosure; and
a processor configured to provide data for generating a two-dimensional image to the primary display and data for generating a three-dimensional image to the secondary display.

2. The computer system of claim 1, wherein the secondary display comprises:
a display device configured to graphically display the status information; and
a lenticular lens disposed over the display device.

3. The computer system of claim 2, wherein the lenticular lens comprises 75 to 100 lines per inch.

4. The computer system of claim 2, wherein the display device comprises electronic paper.

5. The computer system of claim 1, wherein the computer system is configured to provide at least one of an autostereoscopic audio level display, an autostereoscopic radio frequency signal strength display, and an autostereoscopic battery charge level display.

6. The computer system of claim 1, further comprising a software system that when executed by the processor interlaces a plurality of images to generate a three-dimensional image viewable on the secondary display.

7. The computer system of claim 1, wherein the secondary display is configured to provide autostereoscopic viewing of computer system status information when the computer is off.

8. The computer system of claim 1, wherein the secondary display is configured to simultaneously provide a plurality of three dimensional status indications.

9. A method, comprising:
generating, in a computer, a plurality of images each representing a status symbol viewed from a different angle;
providing a composite image of the status symbol based on the plurality of images to an autostereoscopic display device of the computer that is dedicated to displaying status of the computer; and
generating an autostereoscopically displayed image of the status symbol.

10. The method of claim 9, further comprising splitting each of the plurality of images into vertical strips, the width of the strips based on a lenticular lens component of the display.

11. The method of claim 10, further comprising interlacing the vertical strips to form the composite image.

12. The method of claim 9, further comprising generating a composite image of at least one of a three dimensional audio volume of the computer, a three dimensional radio frequency signal strength detected by the computer, and a three dimensional battery charge level of the computer.

13. The method of claim 9, further comprising displaying the composite image last provided to the autostereoscopic display while the computer is powered off.

14. A computer-based device, comprising
means for displaying information generated by the device in two-dimensions; and
means for autostereoscopically displaying device status information;
means for generating device status data configured for three dimensional display;
wherein the means for displaying in two dimensions is separate from the means for autostereoscopically displaying device status.

15. The computer-based device of claim 14, further comprising means for generating a plurality of images each representing a status symbol viewed from a different angle.

16. The computer-based device of claim 15, further comprising means for splitting each of the images into vertical strips in accordance with a lenticular lens component of the means for autostereoscopically displaying.

17. The computer-based device of claim 16, further comprising means for interlacing the vertical strips into a composite image that when viewed via the means for autostereoscopically displaying provides a three-dimensional status display.

18. The computer-based device of claim 14, wherein the means for autostereoscopically displaying device status information maintains displays device status information without the computer-based device being powered.
